(19) United States
(12) Patent Application Publication
(10) Pub. No.: US 2008/0165309 A1
(43) Pub. Date: Jul. 10, 2008

(54) Transflective Liquid Crystal Display

(75) Inventors: Zhibing Ge, Orlando, FL (US); Xinyu Zhu, Orlando, FL (US); Thomas Xinzhang Wu, Orlando, FL (US); Shin-Tson Wu, Orlando, FL (US); Wang-Yang Li, Tainan County (TW); Chung-Kuang Wei, Taipei City (TW)

Correspondence Address: FISH & RICHARDSON PC, P.O. BOX 1022, MINNEAPOLIS, MN, 55440-1022, US

(73) Assignee: CHI MEI OPTOELECTRONICS CORPORATION, Tainan (TW)

(21) Appl. No.: 11/621,343

(22) Filed: Jan. 9, 2007

(51) Int. Cl. G02F 1/1333

(52) U.S. Cl. 349/85

(57) ABSTRACT

A display includes pixel circuits each having a liquid crystal layer, a storage capacitor to store an electric charge corresponding to a data voltage, and a controller to enable different percentages of the data voltage to be applied to the liquid crystal layer depending on an operation state of the display.

### BACKGROUND OF THE INVENTION

The description relates to transflective liquid crystal displays.

Liquid crystal displays (LCD) include transmissive type, reflective type, and transflective type displays. A transmissive type LCD includes a backlight module to generate light that is modulated by liquid crystal cells to generate images. A reflective type LCD includes a reflector to reflect ambient light that is modulated by liquid crystal cells to generate images. A transflective type LCD can operate in a transmissive mode and/or a reflective mode. In one example, each pixel of the transflective LCD is divided into a transmissive part (T sub-pixel) and a reflective part (R sub-pixel). When operating in the transmissive mode, a backlight module generates light that is modulated by the T sub-pixels. When operating in the reflective mode, reflected ambient light is modulated by the R sub-pixels.

### SUMMARY

In one aspect, in general, an apparatus includes a display having pixel circuits. Each pixel circuit includes a liquid crystal layer, a storage capacitor to store an electric charge corresponding to a data voltage, and a controller to enable different percentages of the data voltage to be applied to the liquid crystal layer depending on an operation state of the display.

Implementations of the apparatus may include one or more of the following features. The controller includes a switch. The switch includes a transistor. The display includes a control line coupled to the switches of the pixel circuits, the control line having a first logic state when the display is operating in a transmissive mode and a second logic state when the display is operating in a reflective mode. The controller causes a higher percentage of the data voltage to be applied to the liquid crystal layer when the display is operating in a transmissive mode, and causes the lower percentage of the data voltage to be applied to the liquid crystal layer when the display is operating in a reflective mode. The liquid crystal layer includes liquid crystal molecules having orientations that change depending on an amount of voltage applied to the liquid crystal layer.

Each pixel circuit includes a second capacitor, and the controller controls whether the data voltage is applied to (i) the liquid crystal layer and not the second capacitor, or (ii) to both the liquid crystal layer and the second capacitor. Each pixel circuit includes a second capacitor having an electrode that is electrically floating when the display shows images when operating in a reflective mode. Each pixel circuit includes a second switch connected to provide a discharge path from the electrode of the second capacitor. Each pixel circuit includes a second capacitor, the liquid crystal layer is between a first conductive layer and a second conductive layer, the second capacitor includes a dielectric layer between the second conductive layer and a third conductive layer, and the controller controls whether the second conductive layer is electrically coupled to a third conductive layer.

The apparatus includes a transflective layer that partially transmits light and partially reflects light. The apparatus includes a first linear polarizer, a first half-wave plate, a first quarter-wave plate, a second linear polarizer, a second half-wave plate, and a second quarter-wave plate. The first linear polarizer, the first half-wave plate, and the first quarter-wave plate are positioned on a first side of the liquid crystal layer. The second linear polarizer, the second half-wave plate, and the second quarter-wave plate are positioned on a second side of the liquid crystal layer. The first half-wave plate has an extraordinary axis that is at an angle between 10 to 20 degrees relative to a transmission axis of the first polarizer. The second half-wave plate has an extraordinary axis that is at an angle between 10 to 20 degrees relative to a transmission axis of the second polarizer. The first quarter-wave plate has an extraordinary axis that is at an angle between 70 to 80 degrees relative to the transmission axis of the first polarizer. The second quarter-wave plate has an extraordinary axis that is at an angle between 70 to 80 degrees relative to a transmission axis of the second polarizer. The apparatus includes a compensation film to increase a viewing angle of the display. The compensation film has an ordinary refractive index that is larger than an extraordinary refractive index. The display includes a control unit to control the percentage of the data voltage applied to the liquid crystal layer based on a user activity state. The display includes a control unit to control the percentage of the data voltage applied to the liquid crystal layer based on a level of ambient light.

In another aspect, in general, an apparatus includes a display having pixel circuits. Each pixel circuit includes a liquid crystal layer, in which the display is capable of switching between a transmissive mode and a reflective mode by changing a percentage of a data voltage applied to the liquid crystal layer of each pixel circuit, the data voltage being associated with a gray level.

Implementations of the apparatus may include one or more of the following features. A higher percentage of the data voltage is applied to a portion of the liquid crystal layer when the display is operating in the transmissive mode, and a lower percentage of the data voltage is applied to the same portion of the liquid crystal layer when the display is operating in the reflective mode. Each pixel circuit includes a storage capacitor for storing an electric charge corresponding to the data voltage, a driving transistor for driving the storage capacitor to store the electric charge, and a switch transistor for controlling whether a higher percentage or a lower percentage of the data voltage is applied to the portion of the liquid crystal layer. The pixel circuit includes a switch having a first state and a second state, the switch in the first state enabling the data voltage to be applied to the liquid crystal layer, the switch in the second state enabling the data voltage to be applied to the liquid crystal layer and a second capacitor coupled in series with the liquid crystal layer.

In another aspect, in general, a display includes pixel circuits, each pixel circuit including a liquid crystal layer, in which a portion of the liquid crystal layer is used to modulate light when the display is operating in a transmissive mode, and the same portion of the liquid crystal layer is used to modulate light when the display is operating in a reflective mode. Each pixel circuit includes circuitry to control the amount of tilt of liquid crystal molecules in the liquid crystal layer for a given pixel data according to an operating mode of the display.

Implementations of the apparatus may include one or more of the following features. For a given pixel data, the circuitry controls the liquid crystal molecules to tilt at a larger angle relative to a reference direction when the display is operating in a transmissive mode and to tilt at a smaller angle relative to the reference direction when the display is operating in a reflective mode. The circuitry includes a switch that enables a capacitor to be in series connection with the liquid crystal layer when the display is operating in the reflective mode and short-circuits the capacitor when the display is operating in the transmissive mode.

In another aspect, in general, an apparatus includes a liquid crystal cell, a first capacitor to store an electric charge corresponding to a data voltage associated with a gray-scale level, and a second capacitor positioned in series with the liquid crystal cell, the second capacitor having a first node and a second node. The apparatus includes a first transistor for driving the first capacitor, and a second transistor having a first node and a second node, the first and second nodes of the second transistor being coupled to the first and second nodes, respectively, of the second capacitor.

Implementations of the apparatus may include one or more of the following features. The apparatus includes a third transistor to control discharge of electric charges accumulated at one of the first and second nodes of the second capacitor.

In another aspect, in general, a display includes a first conducting layer, a second conducting layer, a third conducting layer, a dielectric layer between the first and second conducting layers, a liquid crystal layer between the second and third conducting layers, a storage capacitor to apply a pixel data voltage to the first and third conducting layers, and a control unit to short-circuit the first and second conducting layers when operating the display in a reflective mode.

Implementations of the apparatus may include one or more of the following features. The display includes a transflector between the liquid crystal layer and the second conducting layer. The display includes a transflector between the first and second conducting layers.

In another aspect, in general, a method includes storing an electric charge in a storage capacitor of a pixel circuit of a display, the electric charge corresponding to a data voltage, and applying a percentage of the data voltage to a liquid crystal layer of the pixel circuit based on the transmissive or reflective operating mode of the display.

Implementations of the apparatus may include one or more of the following features. Applying a percentage of the data voltage to the liquid crystal layer includes applying a higher percentage of the data voltage to the liquid crystal layer when the display is operating in the transmissive mode, and applying a lower percentage of the data voltage to the liquid crystal layer when the display is operating in the reflective mode. Applying a percentage of the data voltage to the liquid crystal layer includes applying the data voltage to a combination of a second capacitor and the liquid crystal layer. The method includes discharging charges accumulated on a floating electrode of the second capacitor. The method includes controlling a switch to determine whether to apply a higher percentage or a lower percentage of the data voltage to the liquid crystal layer. The liquid crystal layer is between a first conductive layer and a second conductive layer, the second capacitor including a dielectric layer positioned between the second conductive layer and a third conductive layer. Controlling the switch includes controlling whether the second conducive layer is electrically coupled to the third conductive layer.

In another aspect, in general, a method includes sending pixel data to a display capable of operating in a transmissive mode and a reflective mode, the data voltage being independent of the operating mode of the display, and controlling a percentage of the data voltage applied to pixel circuits of the display based on whether the display is operating in the transmissive mode or the reflective mode.

Implementations of the apparatus may include one or more of the following features. Controlling the percentage the data voltage applied to one of the pixel circuits includes controlling whether the data voltage is applied to a capacitor in series with a liquid crystal layer of the pixel circuit, or to the liquid crystal layer but not the capacitor.

In another aspect, in general, a method includes sending a data voltage to a display, the data voltage corresponding to a gray level to be shown on a pixel of the display, the pixel includes a liquid crystal layer, and controlling an amount of tilt of liquid crystal molecules in the liquid crystal layer based on the data voltage and whether the display is operating in a transmissive mode or a reflective mode.

Implementations of the apparatus may include one or more of the following features. Controlling the amount of tilt of liquid crystal molecules includes controlling the liquid crystal molecules to tilt at a larger angle relative to a reference direction when the display is operating in the transmissive mode and to tilt at a smaller angle relative to the reference direction when the display is operating in the reflective mode.

In another aspect, in general, a method includes controlling delivery of pixel data voltages from a data line to a first capacitor, applying pixel data voltages to a liquid crystal cell of the pixel and a second capacitor during a first time period, and short-circuiting the second capacitor to apply the pixel data voltages to the liquid crystal cell during a second time period.

Implementations of the apparatus may include one or more of the following features. The method includes discharging electric charges accumulated at an electrode of the second capacitor.

In another aspect, in general, a method includes discharging charges accumulated on a floating electrode of a capacitor, the capacitor being connected in series with a liquid crystal cell to reduce an amount of pixel data voltage applied to the liquid crystal cell when operating a display in a reflective mode.

Implementations of the apparatus may include one or more of the following features. Discharging the charges includes turning on a switch to allow the charges to flow to a reference node. Discharging the charges includes setting a pixel data voltage of a data line to a reference voltage and electrically connecting the electrode of the capacitor to the data line.

Advantages of the transflective displays can include one or more of the following. A user can use a single switch to select between a transmissive mode or a reflective mode depending on the ambient environment. The display can have a single cell gap and is easy to fabricate, resulting in a high production yield. The display can use a single driving gamma curve for the transmissive and reflective modes and is easy to operate. The display can use an entire pixel region for the transmissive mode or the reflective mode, and does not separate a pixel into distinctive transmissive and reflective sub-regions. The pixels do not have transition regions between distinct transmissive and reflective regions, so the likelihood of trapping ions (e.g., from impurities in the liquid crystal materials) at electrode surfaces and image distortion at transition regions can be reduced, improving the gray-scale or color performance of the display.

### DESCRIPTION OF DRAWINGS

FIG. 1 is a diagram of pixel circuits of a display.

FIGS. 2A and 2B are diagrams of equivalent circuits of a pixel circuit.

FIGS. 3 and 4 are cross sectional views of a display.

FIG. 5 is a schematic diagram of a pixel circuit.

FIGS. 6A and 6B show orientations of liquid crystal molecules.

FIG. 7A is a diagram of a transflector.

FIG. 7B is a cross sectional view of a transflector.

FIG. 8 is a graph.

FIG. 9 is a cross sectional view of a display.

FIGS. 10, 11A, and 11B are graphs.

FIG. 12 is a cross sectional view of a display.

FIGS. 13A and 13B are graphs.

FIGS. 14 and 15 are cross sectional views of displays.

FIG. 16 is a diagram of a pixel circuit.

FIG. 17 is a timing diagram.

FIG. 18 is a cross sectional diagram of a display.

FIGS. 19A and 19B are diagrams of pixel circuits.

### DETAILED DESCRIPTION

The following describes examples of liquid crystal displays that can switch between a transmissive mode and a reflective mode.

### Example 1

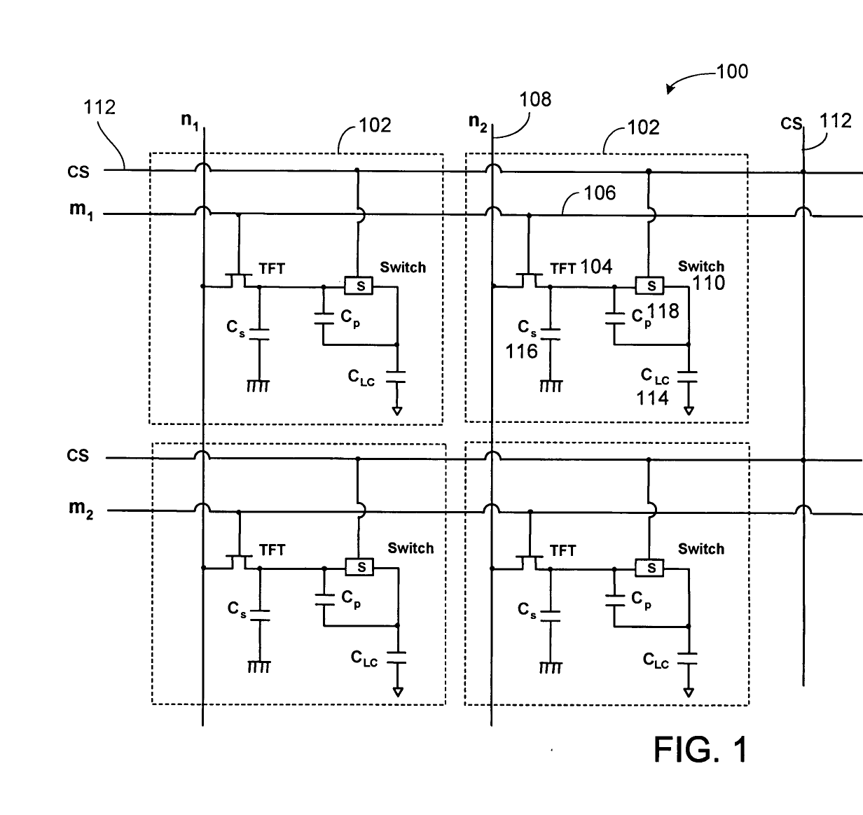

FIG. 1 is a schematic diagram of an example of a switchable transmissive/reflective liquid crystal display 100 that includes a plurality of pixel circuits 102. Each pixel circuit 102 includes a driving thin film transistor (TFT) 104, a storage capacitor C_{S} 116, a liquid crystal cell 114, and a shield capacitor C_{P} 118. During each frame period, each pixel circuit 102 receives pixel data voltages through a corresponding data line 108 (e.g., n1, n2), the pixel data voltage representing a gray-scale level to be shown by the pixel circuit 102. Each pixel circuit 102 includes a controller (e.g., a switch 110) to control a percentage of the pixel data voltage applied to the liquid crystal cell 114. Different percentages of the pixel data voltage are applied to the liquid crystal cell 114 depending on whether the display 100 is operating in the transmissive or reflective mode, allowing the pixel circuit 102 to show a specified gray-scale level.

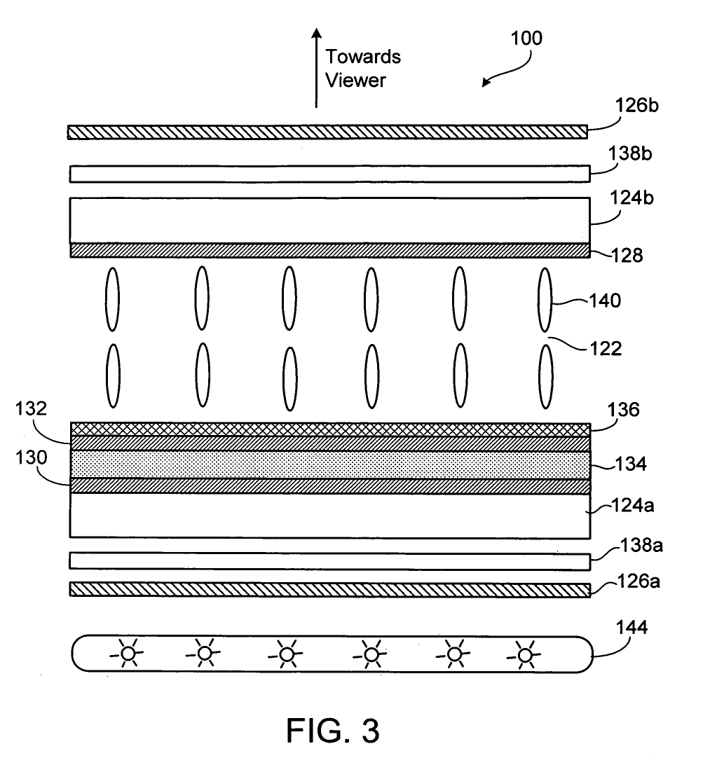

When the display 100 is operating in the transmissive mode, images on the display 100 are formed by light generated by a backlight module 144 (FIG. 3) positioned at a back side of the display 100 (the back side of the display 100 is farther to a viewer than a front side). The light from the backlight module 144 passes the liquid crystal cell 114 once before reaching a viewer. When the display 100 is operating in the reflective mode, images on the display 100 are formed by ambient light or light from an external light source, which travels towards a transflector 136 (FIG. 3) in the display 100 and is reflected by the transflector 136, passing the liquid crystal cell 114 twice before reaching the viewer.

In order to achieve the same luminance (or gray-scale level) for a given pixel data voltage in both the transmissive and reflective modes, the pixel circuit 102 is configured so that the liquid crystal cell 114 has a smaller phase retardation in the reflective mode than in the transmissive mode for the same pixel data voltage. The pixel circuit 102 is configured such that the amount of phase retardation experienced by light passing the liquid crystal cell 114 round-trip in the reflective mode is substantially the same as the amount of phase retardation experienced by light passing the liquid crystal cell 114 once in the transmissive mode for the same pixel data voltage.

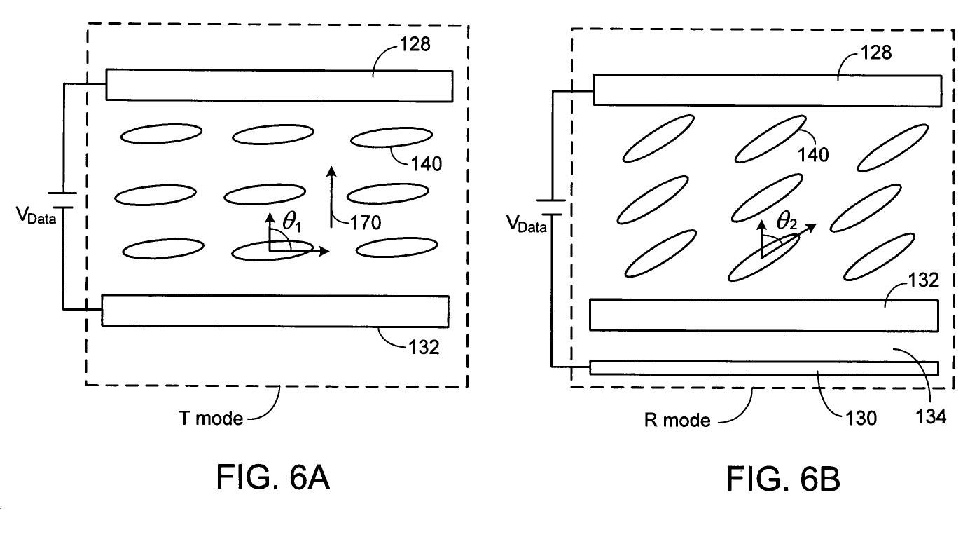

The difference in phase retardation of the liquid crystal cell 114 in the reflective and transmissive modes can be achieved by changing the percentage of the pixel data voltage applied to the liquid crystal cell 114 in the reflective and transmissive modes. For example, a higher percentage of the pixel data voltage is applied to the liquid crystal cell 114 in the transmissive mode, and a lower percentage of the pixel data voltage is applied to the liquid crystal cell 114 in the reflective mode. This is achieved by turning on or off the switch 110 to control whether the shielding capacitor C_{P} 118 is shorted-circuited. Applying a higher percentage of the pixel data voltage to the liquid crystal cell 114 causes liquid crystal molecules in the liquid crystal cell 114 to rotate at greater angles from an initial orientation (e.g., a direction normal to surfaces of substrates 124a and 124b, see FIG. 3), resulting in greater phase retardation, as compared to applying a lower percentage of the pixel data voltage to the liquid crystal cell 114. The rotations of liquid crystal molecules are shown in FIGS. 6A and 6B.

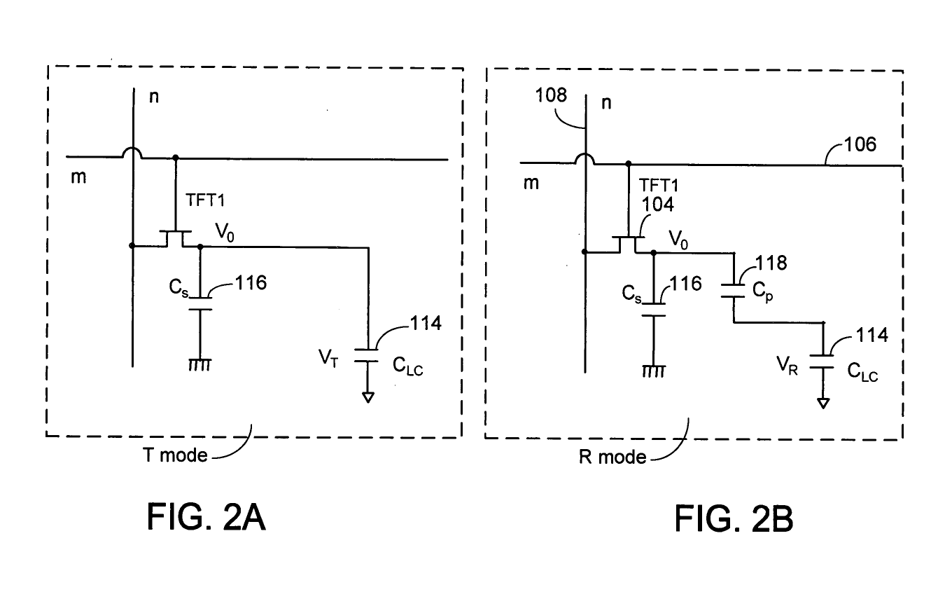

Referring to FIG. 1, the switch 110 is controlled by a control signal on a common select (CS) line 112. The switch 110 has two ends that are connected to two ends, respectively, of the shield capacitor C_{P} 118. The user selects the transmissive mode by turning on (i.e., short-circuiting) the switch 110 so that the two ends of the shield capacitor C_{P} 118 are short-circuited (as shown in FIG. 2A). In the transmissive mode, when the TFT 104 is turned on, a pixel data voltage on a corresponding data line 108 charges the storage capacitor C_{S} 116 and the capacitance C_{LC} of the liquid crystal cell 114. When the TFT 104 is turned off, the voltage level stored across the storage capacitor C_{S} 116 is applied to the liquid crystal cell capacitance C_{LC}. Turning on and off of the TFT 104 is controlled by a control signal on a corresponding gate line 106 (e.g., m1, m2).

The user selects the reflective mode by turning off (i.e., open-circuiting) the switch 110 so that the shield capacitor C_{P} 118 is connected in series with the liquid crystal cell 114 (as shown in FIG. 2B). In the reflective mode, a portion (less than 100%) of the voltage level across the storage capacitor C_{S} 116 is applied to the liquid crystal cell 114. When the TFT 104 is turned on, a driving voltage is applied through the corresponding data line 108 to charge the storage capacitor C_{S} 116 and the liquid crystal cell capacitance C_{LC} and the shield capacitor C_{P}. When the TFT 104 is turned off, the voltage level across the storage capacitor C_{S} 116 is applied to the liquid crystal cell capacitance C_{LC} and the shield capacitor C_{P}.

The control signal on the CS line 112 can be controlled by a timer. In some examples, the user or the operating system of a host device (e.g., a computer) can specify a time duration t in which the display 100 operates in the transmissive mode when there is user activity (e.g., movement at the keyboard, mouse, or buttons on the display). If there is no user activity, the display 100 operates in the transmissive mode for the time duration t, after which the display 100 switches to the reflective mode to reduce power consumption. When the user touches any key on the keyboard or the display 100, or moves the mouse, the display 100 switches back to the transmissive mode. In some examples, the control signal on the CS line 112 can be controlled by a button on the display 100. This allows the user to toggle between the transmissive mode and the reflective mode by pushing the button. In some examples, the control signal on the CS line 112 can be controlled by a sensor that detects the intensity of the ambient light. The display 100 automatically switches to the transmissive mode if the ambient light is below a predetermined level, and switches to the reflective mode if the ambient light is above the predetermined level.

FIG. 2A shows an equivalent circuit of the pixel circuit 102 when the display 100 is operating in the transmissive mode. The switch 110 is turned on (short-circuited) so that a voltage V₀ across the storage capacitor C_{S} 116 is applied directly to the liquid crystal cell 114.

FIG. 2B shows an equivalent circuit of the pixel circuit 102 when the display 100 is operating in the reflective mode. The switch 110 is turned off (open-circuited) so that a voltage V₀ across the storage capacitor C_{S} is applied to both the shield capacitor 118 and the liquid crystal cell 114. As a result, only a portion of the voltage V₀ is applied to the liquid crystal cell 114.

In some examples, the CS line 112 is connected to the switches 110 of all of the pixel circuits 102 in the display 100. By controlling a control signal on the CS line 112, the pixel data voltages sent to the pixel circuits 102 through the data lines 108 can be fully or partially applied to the liquid crystal cell 114. This way, the display 100 can share the same gamma curve for both the transmissive and reflective modes. For a given pixel data sent to a pixel circuit 102, the pixel circuit 102 will show substantially the same luminance or gray scale regardless of whether the display 100 is operating in the transmissive mode or the reflective mode.

The pixel circuits 102 include color filters (not shown) to enable the display 100 to show color images.

Advantages of the display 100 can include one or more of the following. The display 100 can have a high aperture ratio (e.g., greater than 80%), a high transmittance in the bright state (e.g., greater than 80%), a wide viewing angle (e.g., −45° to +45°), and can use a single gray scale gamma curve for both transmissive and reflective modes.

FIG. 3 is a cross sectional view of an example of the switchable transmissive/reflective liquid crystal display 100 (FIG. 1). A liquid crystal layer 122 is positioned between a lower substrate 124a and an upper substrate 124b, which in turn are positioned between a lower polarizer 126a and an upper polarizer 126b that are in crossed configuration. The upper substrate 124b is closer to the viewer than the lower substrate 124a. A transparent common electrode 128 is formed on the inner side of the upper substrate 124b. Pixel electrodes 130 and 132, separated and insulated by a passivation layer 134, are formed on the inner side of the lower substrate 124a. The pixel electrode 130 is coupled to the driving TFT 104 (not shown in FIG. 3). The pixel electrode 132 is coupled to the switch 110 (not shown in FIG. 3).

A transflector 136 is formed on the inner side of the pixel electrode 132. The transflector 136 is partially transparent and partially reflective, and can be made of, e.g., aluminum, silver, or other reflective metals. A lower broadband retardation film 138a is laminated between the lower polarizer 126a and the lower substrate 124a, and an upper broadband retardation film 138b is laminated between the upper polarizer 126b and the upper substrate 124b. Each of the retardation films 138a and 138b can be, e.g., a quarter-wave film. The lower retardation film 138a has an extraordinary axis that is aligned at 45° with respect to a transmission axis of the lower polarizer 126a. The upper retardation film 138b has an extraordinary axis that is aligned at 45° with respect to a transmission axis of the upper polarizer 126b. The transmission axis of the upper polarizer 126b is crossed with respect to the transmission axis of the lower polarizer 126a.

The liquid crystal layer 122 can include liquid crystal material MLC-6608, available from Merck, Darmstadt, Germany. The substrates 124a and 124b can be made of, e.g., glass. The electrodes 128, 130, and 132 can be made of, e.g., indium tin oxide. The passivation layer 134 can be made of, e.g., silicon oxide (SiOx) or silicon nitride (SiNx). The retardation films 138a and 138b can be uniaxial A film, available from Grafix Plastics, Cleveland, Ohio. Uniaxial A films are described in X. Zhu et al, “Analytical Solutions for Uniaxial-Film-Compensated Wide-View Liquid Crystal Displays,” Journal of Display Technology, Vol. 2, No. 1, 2006, pages 2 to 20, the contents of which are incorporated by reference.

In this description, the “inner” side of a layer refers to the side that is closer to the liquid crystal layer 122, and the “outer” side of the layer refers to the side that is farther from the liquid crystal layer 122. The terms “upper” and “lower” are used to describe relative positions of the components of the display 100 as shown in the figures. The display 100 can have different orientations.

The liquid crystal layer 122 has liquid crystal molecules 140 that are vertically aligned, i.e., substantially aligned along a direction normal to the surfaces of the substrates 124a and 124b, when no voltage is applied to the liquid crystal layer 122. Because the polarizers 126a and 126b are crossed, the pixel circuit 102 operates in a normally black mode, meaning that the pixel circuit 102 is in a dark state when no voltage is applied to the liquid crystal layer 122. The display 100 operates in a normally black mode for both the transmissive and reflective modes.

The following describes how the layers of the pixel circuit 102 change the polarization of light in the transmissive and reflective modes. In the example below, the retardation films 138a and 138b are quarter-wave films.

When the display 100 operates in the transmissive mode, the gray-scale level of the pixel circuit 102 is determined by the amount of modulation applied to unpolarized light generated by the backlight module 144. The unpolarized light passes the lower polarizer 126a and changes to linearly polarized light having a polarization parallel to the transmission axis of the polarizer 126a. After the linearly polarized light passes the quarter-wave retardation film 138a, the light changes to a circularly polarized light, which can have, e.g., a right-handed circular polarization.

In the transmissive mode, the pixel data voltage (either from the data line 108 or from the storage capacitor C_{S} 116) is fully applied to the liquid crystal layer 122. When the pixel data voltage is below a threshold, the vertically aligned liquid crystal molecules 140 have a small retardation for incident light at normal incidence. The light maintains the circular polarization (e.g., right-handed) after passing the liquid crystal layer 122 and is converted back to linearly polarized light after passing the quarter-wave retardation film 138b. The linearly polarized light has a polarization that is perpendicular to the transmission axis of the polarizer 126b and is absorbed by the polarizer 126b, resulting in a dark state.

When a voltage above the threshold voltage is applied to the liquid crystal layer 122, the liquid crystal layer 122 has a phase retardation that is a function of the applied voltage. When the applied voltage has a certain value, the phase retardation of the liquid crystal layer 122 is similar to that of a half-wave plate. A right-handed circularly polarized light (formed after passing the quarter-wave retardation film 138a) is changed to a left-handed circularly polarized light after passing the liquid crystal layer 122. After the left-handed circularly polarized light passes the quarter-wave retardation film 138b, the light is converted back to a linearly polarized state with its polarization axis parallel to the transmission axis of the polarizer 126b. The linearly polarized light passes the polarizer 126b, resulting in a bright state.

In designing the display 100, the cell gap d of the liquid crystal layer 122 and the liquid crystal material are selected such that Δn·d=λ/2 so that the liquid crystal layer 122 behaves similar to a half-wave plate in the bright state in the transmissive mode. The parameter Δn equals nₑ−nₒ, where nₑ and nₒ are the extraordinary and ordinary refractive indices, respectively, of the liquid crystal material. In some examples, Δn·d is selected to be slightly larger than λ/2 because there may be a small amount of phase loss at boundaries of the liquid crystal layer, and a higher Δn d allows the bright state to be achieved at a lower pixel data voltage. Selection of the liquid crystal material may take into consideration factors such as a large Δn value to reduce the required cell gap, a high dielectric anisotropy (Δε) to reduce the on-state driving voltage, and a low viscosity to reduce the response time.

Simulations or experiments can be performed to obtain a voltage-dependent light efficiency curve of the pixel circuit 102. The on-state (or bright state) voltage V0 corresponding to maximum light efficiency of the pixel circuit 102 and the dark state voltage Vdark corresponding to minimum light efficiency are determined. For example, if 256 gray scale levels are used, then 256 gray scale voltages from Vdark and V0 (Vdark=gray scale 0 and V0=gray scale 255) that correspond to 256 gray scale levels are determined and stored in a lookup table. When the display 100 receives digital pixel data representing gray scale levels of the pixels, the digital pixel data are converted to analog pixel data voltages using the lookup table, and the pixel data voltages are used to drive the pixel circuits 102 to corresponding gray scale levels.

When the display 100 is operating in the reflective mode, the gray-scale level of the pixel circuit 102 is determined by the amount of modulation applied to the light incident from a front side of the display 100 and reflected by the transflector 136. The incident light becomes a linearly polarized light after passing the upper polarizer 126b, and is converted to left-handed circularly polarized light after passing the upper quarter-wave retardation film 138b.

In the reflective mode, a portion of the pixel data voltage (either from the data line 108 or from the storage capacitor C_{S} 116) is applied to the liquid crystal layer 122. When the voltage applied across the liquid crystal layer 122 is below the threshold voltage, the left-handed circularly polarized light experiences substantially no phase retardation as the light passes the liquid crystal layer 122. The left-handed circularly polarized light is reflected by the transflector 136 and becomes right-handed circularly polarized light. On the return trip, the right-handed circularly polarized light experiences substantially no phase retardation as the light passes the liquid crystal layer 122. After passing through the quarter-wave retardation film 138b, the circularly polarized light is converted to linearly polarized light having a polarization perpendicular to the transmission axis of the upper polarizer 126b, resulting in a dark state.

When the voltage applied across the liquid crystal layer 122 has a certain level such that the liquid crystal layer 122 has a phase retardation similar to a quarter-wave plate, the left-handed circularly polarized light (from the quarter-wave retardation film 138b) is converted to linearly polarized light after passing the liquid crystal layer 122. After being reflected by the transflector 136, on the return trip, the linearly polarized light is changed to left-handed circularly polarized light after passing the liquid crystal layer 122. After passing the quarter-wave retardation film 138b, the left-handed circularly polarized light is converted to linearly polarized light having a polarization parallel to the transmission axis of the polarizer 126b, resulting in a bright state.

As described above, when the display 100 is in the transmissive mode, the pixel circuit 102 is in a bright state when the liquid crystal layer 122 has a phase retardation equivalent to a half-wave plate. When the display 100 is in the reflective mode, the pixel circuit 102 is in a bright state when the liquid crystal layer 122 has a phase retardation equivalent to a quarter-wave plate. The difference in phase retardation of the liquid crystal layer 122 can be achieved by changing the percentage of the pixel data voltage applied to the liquid crystal layer 122.

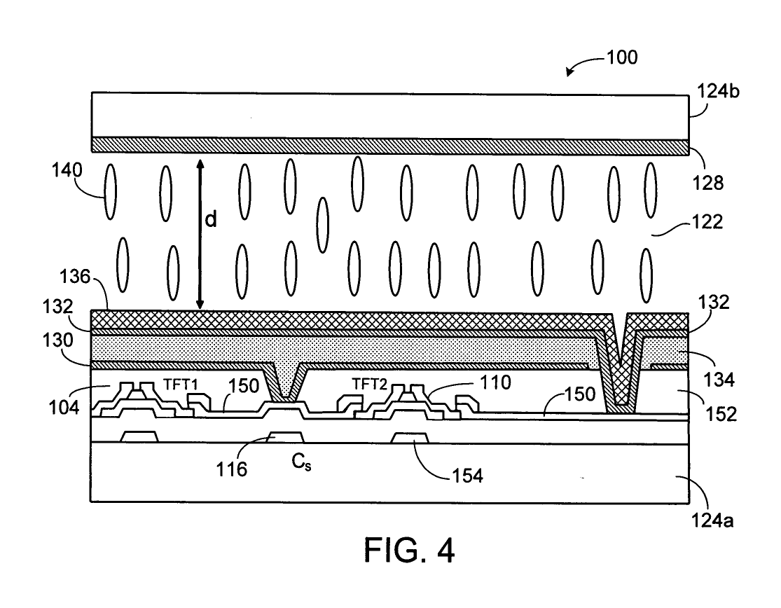

FIG. 4 is a cross sectional diagram of an example of the display 100, showing the driving transistor and the switch. In this example, the switch 110 is a thin-film-transistor. A liquid crystal layer 122 is positioned between a lower substrate 124a and an upper substrate 124b. A transparent common electrode 128 is formed on the inner surface of the upper substrate 124b. A driving TFT 104 is formed above the lower substrate 124a and connected to a storage capacitor C_{S} 116 through a transparent conductive layer 150. The driving TFT 104 is also connected to the switch TFT 110. The driving TFT 104 is electrically connected to a first transparent pixel electrode 130. Both TFTs 104 and 110 are covered and protected by a passivation layer 152. In this example, the TFTs 104 and 110 are n-type TFTs.

A second passivation layer 134 is formed on the first pixel electrode 130. A second transparent pixel electrode 132 is formed on the passivation layer 134 and is connected to the switch TFT 110 through the conductive layer 150. Each of the common electrode 128, the first pixel electrode 130, and the second pixel electrode 132 can be made of, e.g., indium tin oxide (ITO) or indium zinc oxide (IZO). Different electrodes can be made of the same material or different materials. The second pixel electrode 132 is electrically insulated from the first pixel electrode 130 by the passivation layer 134. A transflector layer 136 (which is partially transparent and partially reflective) is formed on the pixel electrode 132.

In the example of FIG. 4, the user can select between the transmissive or reflective mode by controlling a control signal applied to a gate 154 of the switch TFT 110. When the signal on the gate 154 has a high level and turns on the switch TFT 110, the driving TFT 104 is electrically connected to the electrode 132 through the switch TFT 110. The voltage from the data line 108 (not shown in FIG. 4) is fully applied to the liquid crystal layer 122. When the signal on the gate 154 has a low level and turns off the switch TFT 110, the driving TFT 104 is connected to the electrode 130 and not connected to the electrode 132. The electrodes 130, 132 and the passivation layer 134 in combination function as a shield capacitor C_{P} 118 (FIG. 1). The pixel data voltage from the data line 108 is applied to both the passivation layer 134 and the liquid crystal layer 122, so that only a portion of the pixel data voltage from the data line 108 is applied to the liquid crystal layer 122.

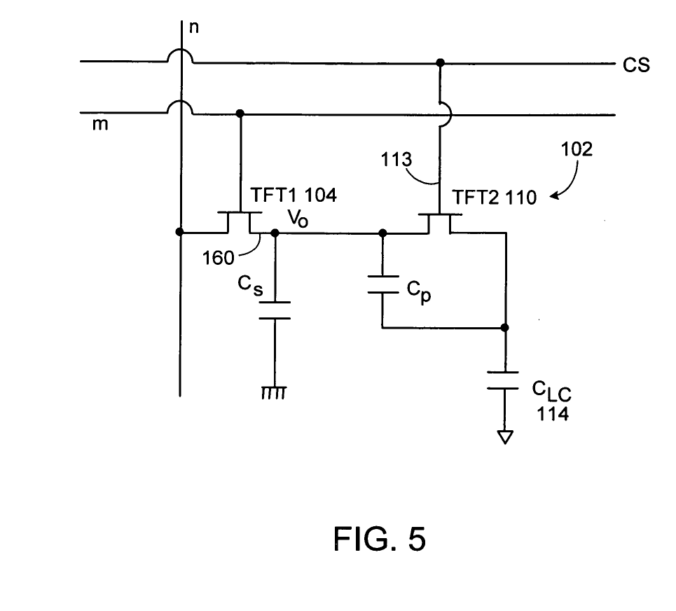

FIG. 5 is a circuit diagram of the pixel circuit 102 of FIG. 4. When a driving voltage V₀ is output from the driving TFT 104 through a node 160, the voltage applied to the liquid crystal layer 122 (represented by the liquid crystal capacitance C_{LC} 114) in the transmissive mode is V_{T}=V₀. The voltage applied to the liquid crystal layer 122 in the reflective mode is

$${V}_{R} = \frac{{C}_{P}}{{C}_{LC } + {C}_{P}} {V}_{0} .$$

The ratio between V_{T} and V_{R} can be tuned by adjusting the ratio between the liquid crystal capacitance C_{LC} 114 and the shield capacitance C_{P} 118 For example, the shield capacitance C_{P} 118 can be changed by varying the dielectric constant and thickness of the passivation layer 134.

In some examples, the liquid crystal material and the cell gap of the liquid crystal layer 122 are first determined based on optical characteristics of the display 100 in the transmissive mode. The capacitance value of the shield capacitor C_{P} 118 is then selected so that the reflective mode has similar optical characteristics as the transmissive mode. For example, the capacitance of the shield capacitor C_{P} 118 can be selected so that when a pixel data voltage V0 is applied to both the shield capacitor C_{P} 116 and the liquid crystal layer 112 in the reflectance mode (where V0 is the pixel data voltage that results in a bright state in the transmittance mode), the voltage VR=V0*C_{P}/(C_{LC}+C_{P}) applied to the liquid crystal layer 122 causes the liquid crystal layer 122 to behave similar to a quarter-wave plate. The capacitance of the shield capacitor C_{P} 118 can be adjusted to obtain a best match between the voltage-transmittance characteristics and the voltage-reflectance characteristics of the display 100.

FIG. 6A shows the orientations of the liquid crystal molecules 140 when a pixel data voltage Vdata is applied to the liquid crystal layer 122 when the display 100 is in the transmissive mode. The liquid crystal molecules 140 tilt at an angle θ1 relative to the normal direction 170. FIG. 6B shows the orientations of the liquid crystal molecules 140 when the same pixel data voltage Vdata is applied to the liquid crystal layer 122 and the passivation layer 134 when the display 100 is in the reflective mode. The liquid crystal molecules 140 tilt at an angle θ2 relative to the normal direction 170. As can be seen from FIGS. 6A and 6B, for a given pixel data voltage Vdata, the liquid crystal molecules 140 tilt at larger angles relative to the normal direction 170 than when the display 100 is in the reflective mode, i.e., θ1>θ2. Thus, light passing the liquid crystal layer 122 experiences a greater phase retardation in the transmissive mode than in the reflective mode.

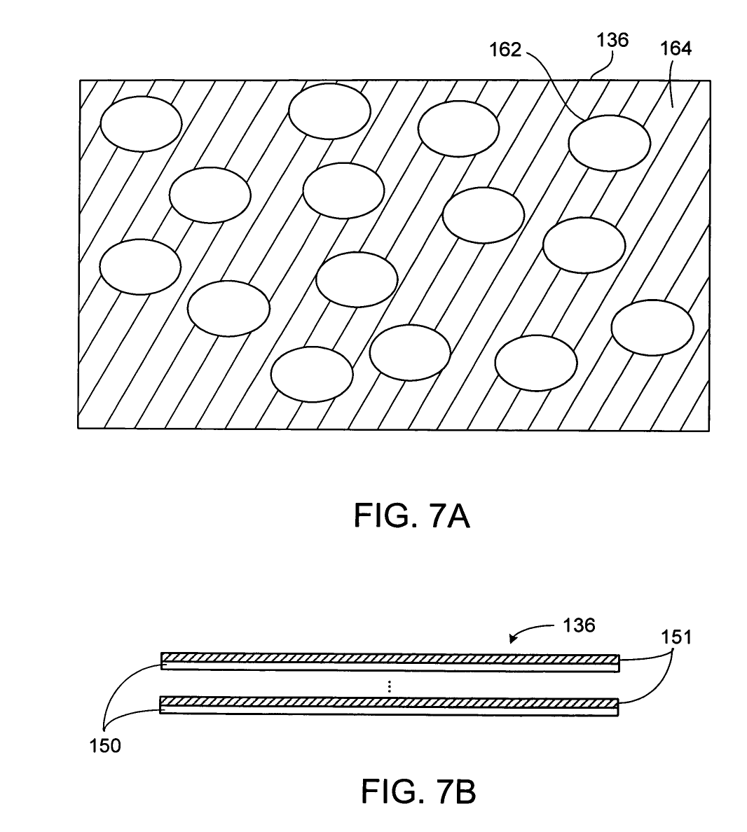

FIG. 7A is a diagram of an example of the transflector 136, which can be a reflective metal layer having openings 162 to allow some light to pass. The reflective metal layer can be made of, e.g., aluminum, silver, or other reflective metals, and has a thickness of, e.g., 50 to 200 nm. The area ratio between the metal surface 164 and the openings 162 can be configured according to the requirement of the transflective display 100. For example, the area ratio can be from 1:4 to 4:1. In some examples, the transflector 136 can be a continuous thin layer of metal film that is partially transparent and partially reflective, and can be made of, e.g., aluminum, silver, or other reflective metals, and having a thickness of, e.g., 20 to 100 nm.

FIG. 7B is a cross sectional diagram of another example of the transflector 136. In this example, the transflector 136 includes a stack of alternating dielectric layers having different refractive indices, such as SiO₂ layers 150 alternating with TiO₂ layers 151. Each of the layers 150 can have a thickness of, e.g., 20 to 150 nm, and each of the layers 151 can have a thickness of, e.g., 20 to 150 nm.

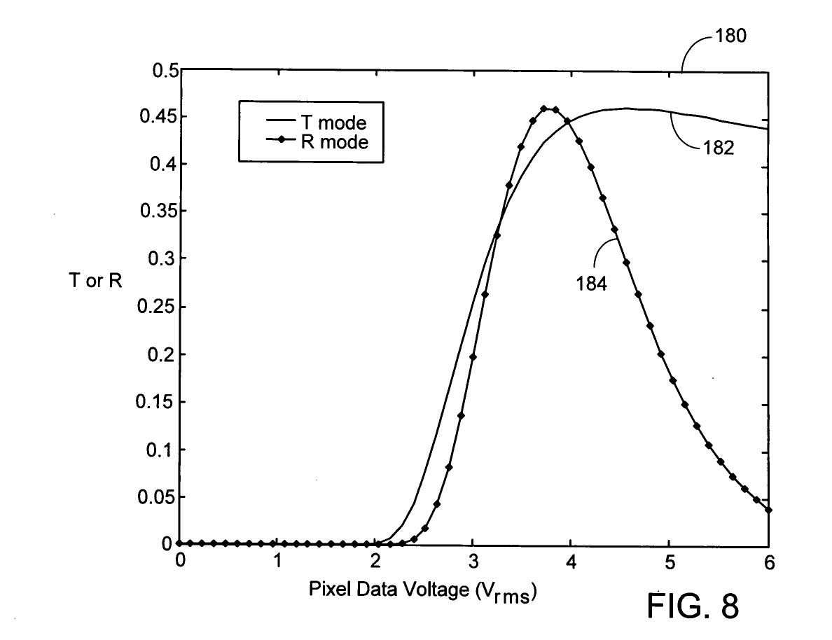

FIG. 8 is a graph 180 having a V-T curve 182 and a V-R curve 184 that are obtained by simulation. The V-T curve 182 and the V-R curve 184 represent the relationships between the transmittance and reflectance, respectively, of the pixel circuit 102 and the pixel data voltage provided to the pixel circuit 102 through the data line 108 when the display 100 is operating in the transmittance mode and the reflective mode, respectively.

In this example, the passivation layer 134 is SiO₂ having a dielectric constant 3.9 and a thickness 0.8 μm. The liquid crystal material in the liquid crystal layer 122 is MLC-6608, available from Merck, having a parallel dielectric constant ε_{∥}=3.6, a perpendicular dielectric constant ε_{⊥}=7.8, and elastic constants K₁₁=16.7, K₃₃=18.1. The retardation d·Δn of the liquid crystal layer 122 is set at 0.40 μm, where d represents a thickness of the liquid crystal layer 122 and Δn represents the optical anisotropy (difference between two principal indices) of the liquid crystal material.

The curves 182 and 184 overlap when the pixel data voltage is less than 2V, which indicates that the display 100 has the same dark state in the transmissive and reflective modes. The curves 182 and 184 have similar wave forms when the pixel data voltage is between 2V to about 3.75V, indicating that the display 100 can share the same gamma curve for the transmissive and reflective modes to generate gray-scale or color images. The differences in gray scale or color responses between the transmissive and reflective modes are small.

### Example 2

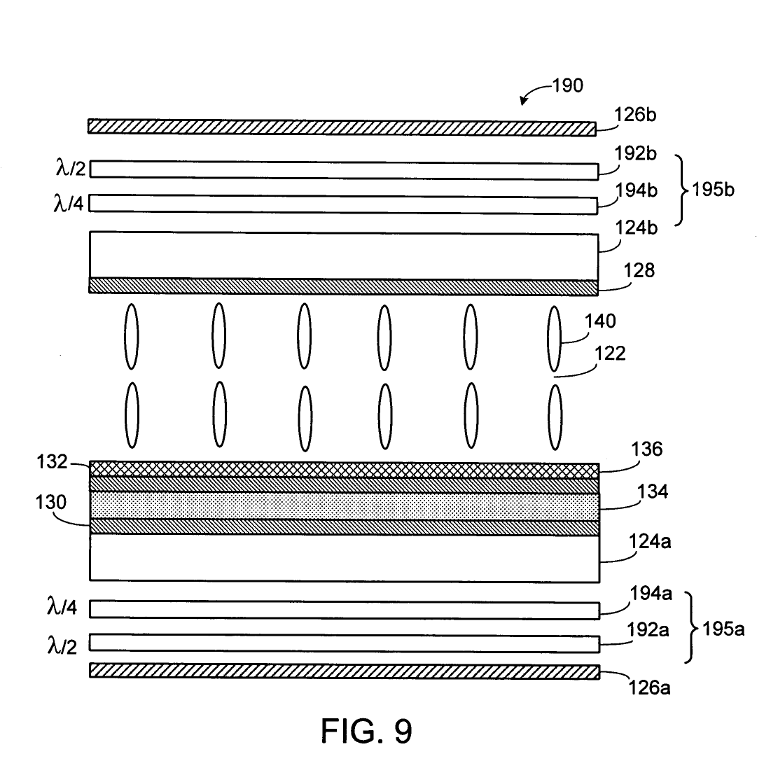

FIG. 9 is a cross sectional diagram of an example of a display 190 that is similar to the display 100 in FIG. 3, except that the broadband retardation films 138a and 138b in FIG. 3 are each replaced by two monochromatic films. A monochromatic lower half-wave plate 192a and a monochromatic lower quarter-wave plate 194a are positioned between a lower polarizer 126a and a lower substrate 124a, with the lower quarter-wave plate 194a closer to the liquid crystal layer 122 than the lower half-wave plate 192a. A monochromatic upper half-wave plate 192b and a monochromatic upper quarter-wave plate 194b are positioned between an upper polarizer 126b and an upper substrate 124b, with the upper quarter-wave plate 194b closer to the liquid crystal layer 122 than the upper half-wave plate 192b.

The lower half-wave plate 192a has an extraordinary axis aligned at 15° with respect to the transmission axis of the lower polarizer 126a. The lower quarter-wave plate 194a has an extraordinary axis aligned at 75° with respect to the transmission axis of the lower polarizer 126a. The upper half-wave plate 192b has an extraordinary axis aligned at 15° with respect to the transmission axis of the upper polarizer 126b. The upper quarter-wave plate 194b has an extraordinary axis aligned at 75° with respect to the transmission axis of the upper polarizer 126b. The arrangement of the half-wave plates and the quarter-wave plates are described in “Achromatic Combinations of Birefringent Plates: Part I. An Achromatic Circular Polarizer” by S. Pancharatnam, Proceedings of Indian Academy of Science, volume 41, section A, 1955, pages 130 to 136, herein incorporated by reference.

In some examples, when designing the display 190, the materials for the half-wave plates 192a, 192b (collectively referenced as 192) and the quarter-wave plates 194a, 194b (collectively referenced as 194) are selected, and the thicknesses of the half-wave plates 192 and the quarter-wave plates 194 are determined such that the half-wave plates and quarter-wave plates provide π/2 and π/4 phase retardation, respectively, at a selected wavelength, representing one of the wavelengths shown on the display 190. Assume that the selected wavelength is λ=550 nm, the material for the half-wave plates 192 has an optical anisotropy Δn=0.0034 at 550 nm, and the material for the quarter-wave plates 194 has an optical anisotropy Δn=0.0015. The thicknesses d for the half-wave plates 192 and quarter-wave plates 194 can be determined to be 80.88 μm and 91.67 μm, respectively.

When the monochromatic films 192a and 194a are aligned in directions described above, the combination of the films 192a and 194a can function as a broadband quarter-wave plate 195a. Similarly, when the monochromatic films 192b and 194b are aligned in directions described above, the combination of the films 192b and 194b can function as a broadband quarter-wave plate 195b. The broadband quarter-wave plates 195a and 195b allows the dark state to remain dark for a broad range of wavelengths.

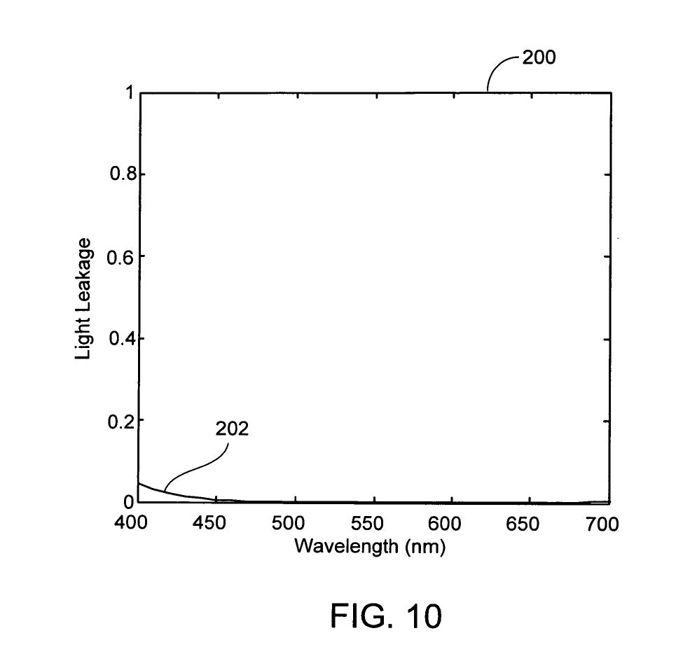

FIG. 10 is a graph 200 having a curve 202 representing a relationship between the reflectance and the wavelength for a pixel in the dark state when the display 190 is operating in a reflective mode. Because the pixel is in the dark state, ideally there should not be any reflected light, so the reflectance can be considered to be a measure of light leakage. FIG. 10 shows that the combination of plates 192a and 194a and the combination of plates 192b and 194b work well as broadband quarter-wave plates to cause the light leakage from the reflective mode to be less than 1% of the incidence light when the wavelength of incident light is in a range from 450 nm to 650 nm.

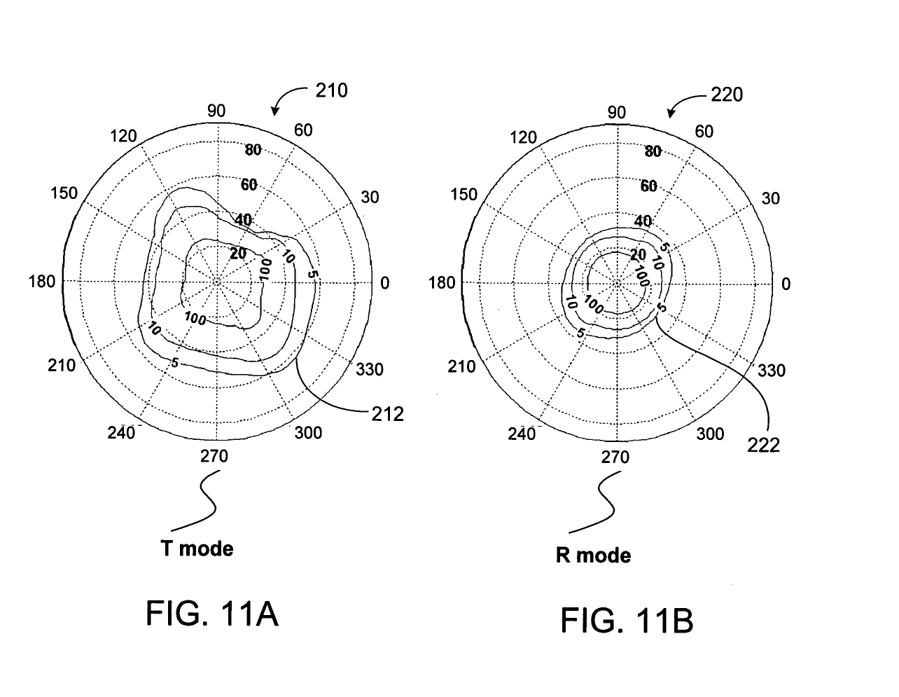

FIG. 1A is a graph 210 showing iso-contrast curves 212 for the display 190 operating in the transmissive mode. FIG. 11B is a graph 220 showing iso-contrast curves 222 for the display 190 operating in the reflective mode. The curves 212 and 222 are obtained using simulation. In this example, the liquid crystal layer 122 has the same properties as those of the liquid crystal layer 122 used in the simulation for generating the graph 180 in FIG. 8. The iso-contrast graphs 210 and 220 can be used to characterize the viewing angle performance of the display 190. The graph 210 shows that the display 190 can achieve a 10:1 or higher contrast ratio when the viewing angle is within a 40° cone for the transmissive mode, and a 30° cone for the reflective mode.

### Example 3

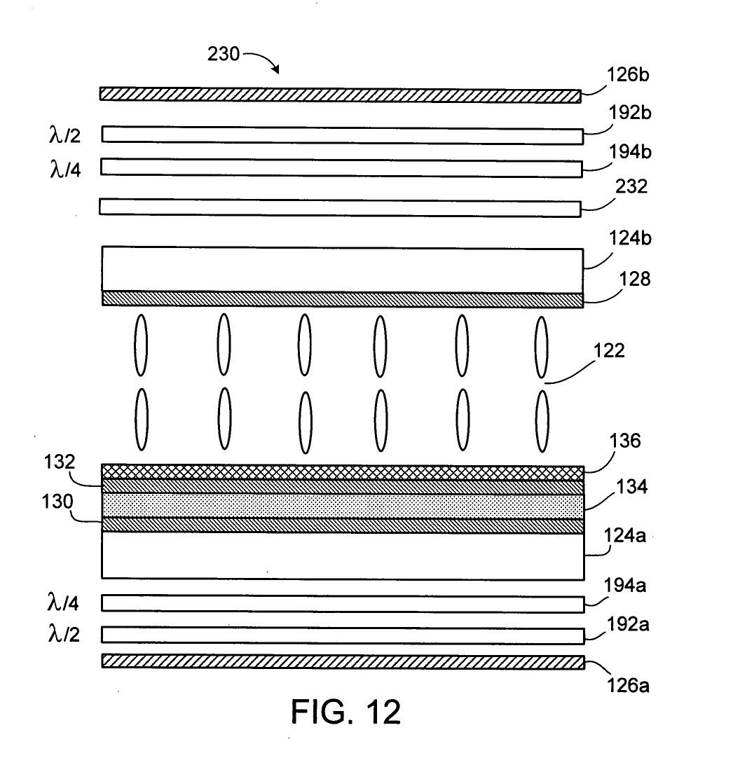

FIG. 12 is a cross sectional diagram of an example of a display 230 that is similar to the display 190, except that the display 230 has an additional compensation film that can enhance the viewing angle of the display 230. The orientations of the polarizers 126a, 126b, half-wave plates 192a, 192b, and quarter-wave plates 194a, 194b in the display 230 are similar to those in the display 190. A retardation film 232, functioning as a compensation film, is laminated between the upper substrate 124b and the upper quarter-wave plate 194b.

The compensation film 232 can be, e.g., a negative C plate having a retardation d·Δn equal to about 0.26 μm. The negative C plate has a homeotropic alignment and an ordinary refractive index (nₒ) that is larger than an extraordinary index (nₑ). In this example, the liquid crystal layer 122 has a retardation d·Δn equal to about 0.40 μm at a wavelength λ=550 nm. Negative C plates are described in X. Zhu et al, “Analytical Solutions for Uniaxial-Film-Compensated Wide-View Liquid Crystal Displays,” Journal of Display Technology, Vol. 2, No. 1, 2006, pages 2 to 20.

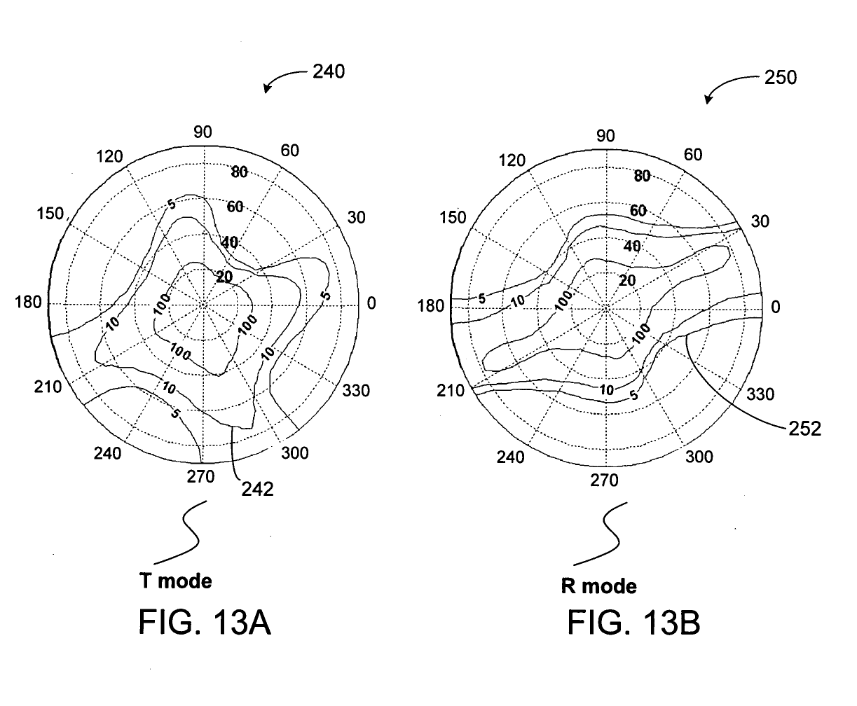

FIG. 13A is a graph 240 showing iso-contrast curves 242 for the display 230 operating in the transmissive mode. FIG. 13B is a graph 250 showing iso-contrast curves 252 for the display 230 operating in the reflective mode. The curves 242 and 252 are obtained using simulation. The graph 240 shows that the display 230 in the transmissive mode can achieve a 10:1 contrast ratio for viewing angles greater than 40° at most directions, and for viewing angles up to 60° at some directions. The graph 250 shows that the display 230 in the reflective mode can achieve a 10:1 contrast ratio for viewing angles greater than 40° at most directions, and for viewing angles up to about 90° at some directions.

### Example 4

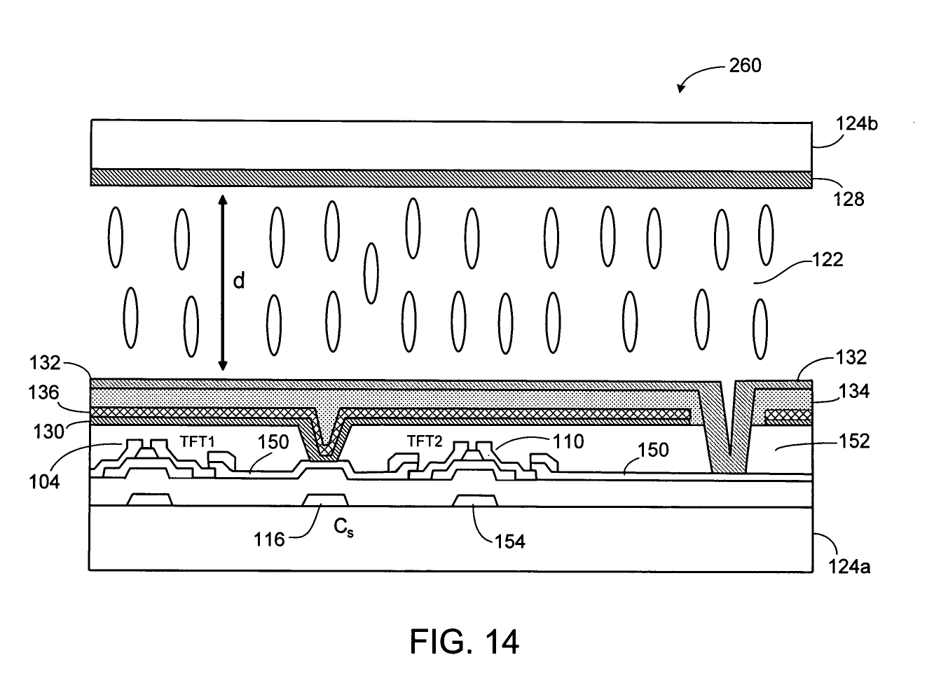

FIG. 14 is a cross sectional diagram of an example of a display 260 that is similar to the display 100 of FIG. 4 except that the transflective layer 136 is formed directly on the pixel electrode 130, and the passivation layer 134 is formed on the transflective layer 136. In the display 260, the pixel electrode 130 can be made of a conducting material that is similar to that of the pixel electrode 132. This reduces the possibility that charges or ions (e.g., impurities of the liquid crystal material) will accumulate to the surface of the pixel electrode 132.

### Example 5

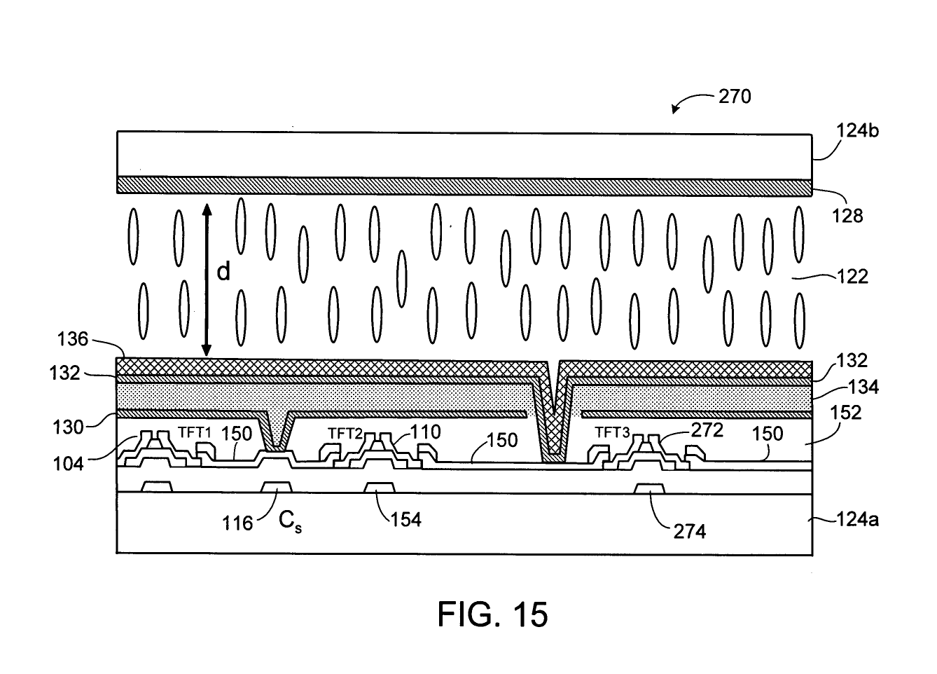

FIG. 15 is a cross sectional diagram of an example of a display 270 that is similar to the display 100 of FIG. 4, with the addition of a TFT 272 that is used for discharging charges accumulated on the pixel electrode 132 in the reflective mode. When in the reflective mode, the pixel electrode 132 is electrically floating. Electric charges from ions as impurities of the liquid crystal material may accumulate on the surface of the electrode 132, modifying the portion of the pixel data voltage applied to the liquid crystal layer 122, adversely affecting the image quality of the display 270.

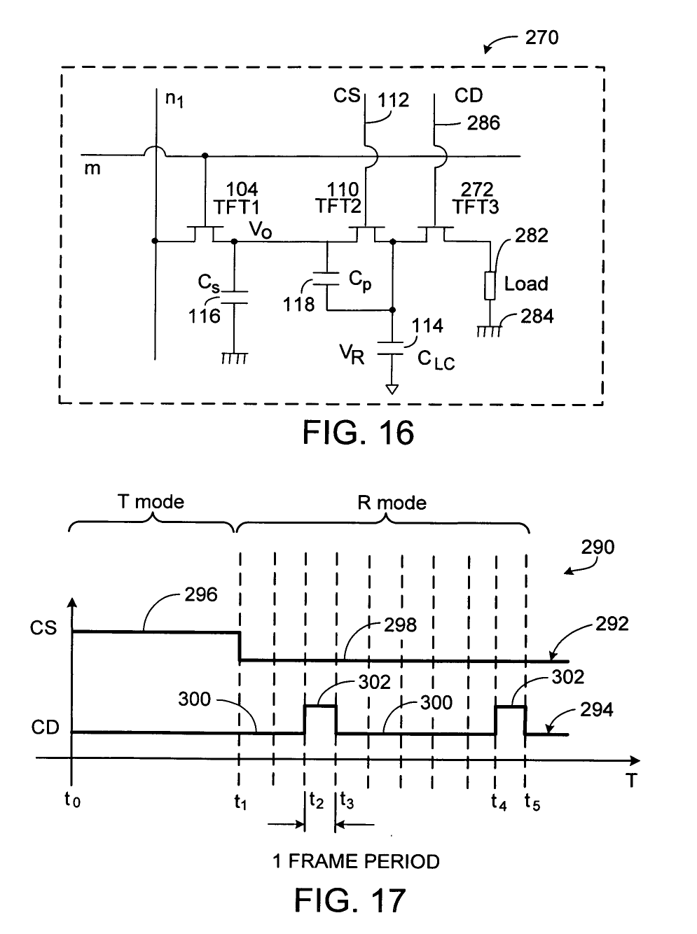

One node (e.g., drain) of the TFT 272 is electrically connected with the pixel electrode 132 through the conductive layer 150, and another node (e.g., source) of the TFT 272 is electrically connected to a load 282 (e.g., a resistor) (see FIG. 16). The load 282 is connected to electric ground 284 through the conductive layer 150. The TFT 272 can be controlled by a control signal applied to a gate 274 of the TFT 272.

When the display 270 is operating in the reflective mode, the switch TFT 110 is turned off and the pixel electrode 132 is electrically floating. Charges, if any, accumulated on the surface of the pixel electrode 132 can be discharged by turning on the TFT 272. This is useful in applications such as displaying static images in the reflective mode for an extended period of time.

FIG. 16 is a diagram of a pixel circuit of the display 270. A discharge signal is applied through a CD signal line 286 to control the TFT 272. In some examples, a common discharge signal is applied to the TFT 272 of all the pixel circuits in the display 270.

FIG. 17 is a timing diagram 290 showing an example of a waveform 292 of the control signal on the CS signal line 112 and a waveform 294 of the discharge signal on the CD signal line 286 during operation of the display 270. During time t0 to t1, the display 270 operates in the transmissive mode. The control signal on the CS line 112 is at a logic high level 296 and turns on the switch TFT 110, short-circuiting the two ends of the shield capacitor C_{P} 118. The pixel data voltage is fully applied to the liquid crystal cell capacitance C_{LC} 114.

During time t1 to t5, the display 270 operates in the reflective mode. The control signal on the CS signal line 112 is at a logic low level 298 and turns off the switch TFT 110, so the pixel data voltage is partially applied to the liquid crystal cell capacitance C_{LC} 114. The discharge signal on the CD signal line 286 is normally at a logic low state 300 (e.g., during time t0 to t2 and t3 to t4), turning off the TFT 272.

Periodically, every j frames (j=6 in this example), the discharge signal on the CD signal line 286 turns to a logic high state 302. For example, during time t2 to t3 and t4 to t5, the discharge signal CD changes to the logic high state 302 and turns on the TFT 272, causing the charges accumulated on the pixel electrode 132 to be discharged through the load 282 to ground 284. The discharge signal on CD line 286 is at the logic high level 302 for about one frame period, in which the display 270 shows a dark image because the voltage across the liquid crystal layer 122 drops to ground voltage level. This way, the charges accumulated on the pixel electrode 132 is discharged periodically. Because the duration of the black frame is short (e.g., 1/60 second when the frame rate is 60 frames per second) and the insensitivity of human eyes to black images, inserting a black frame every j frames (j≧5) periodically has little effect on the overall perception of the images shown on the display 270.

### Example 6

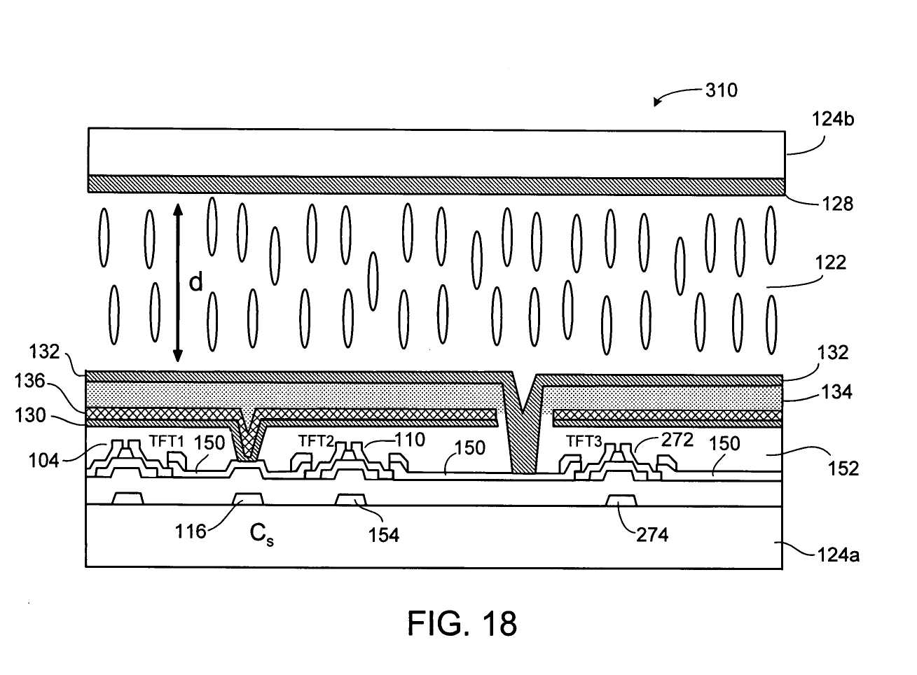

FIG. 18 is a cross sectional diagram of an example of a display 310 that is similar to the display 260 of FIG. 14, except that each pixel circuit of the display 310 includes an additional TFT 272 and a load (not shown) for discharging charges accumulated on the pixel electrode 132. The function of the TFT 272 of the display 310 in FIG. 18 is similar to the TFT 272 of the display 270 in FIG. 15.

### Example 7

The display 100 of FIGS. 1 to 5 when operating in the reflective mode can have black frames inserted periodically to discharge charges (if any) accumulated on the pixel electrode 132 after showing a predetermined number of normal frames.

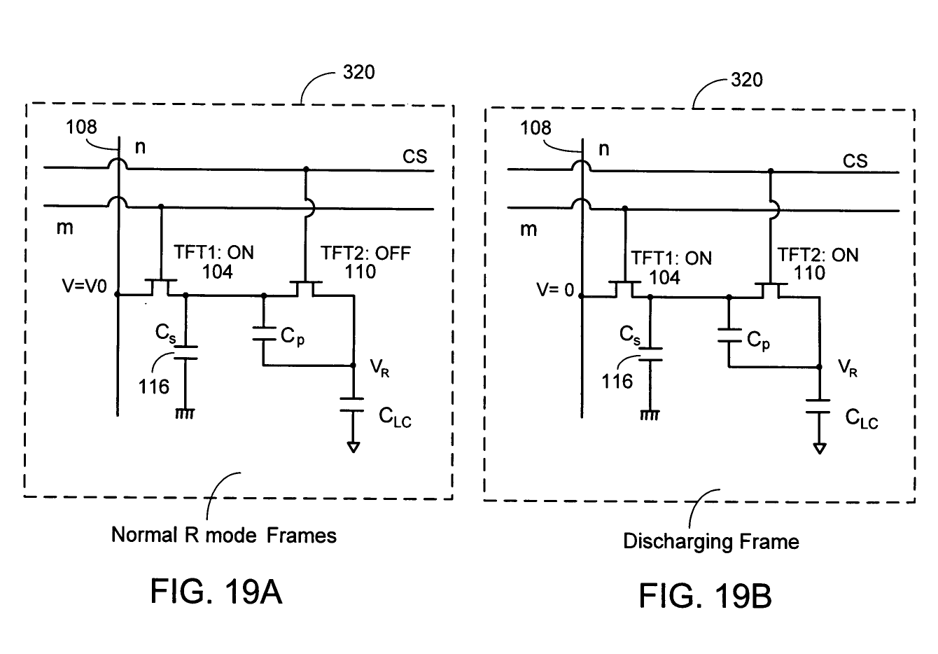

Referring to FIG. 19A, when the display 100 is operating in the reflective mode and showing normal image frames, the switch TFT 110 is turned off. The driving TFT 104 is turned on during a portion of the frame period to allow pixel data voltage (e.g., V₀) to be written to the storage capacitor C_{S} 116.

Referring to FIG. 19B, when the display 100 is operating in the reflective mode and showing a black frame, the pixel data voltage on the data line 108 is set to 0V, and the switch TFT 110 is turned on so that accumulated charges are discharged through the switch TFT 110 and the driving TFT 104. The allows the charges accumulated on the pixel electrode 132 to be discharged periodically. The display 100 can have a frame rate of, e.g., 60 frames per second. Due to the high frame rate and the insensitivity of human eyes to black images, insertion of dark frames periodically has little effect on the overall perception of the images shown on the display 100.

A number of embodiments of the invention have been described. Nevertheless, it will be understood that various modifications may be made without departing from the spirit and scope of the invention. For example, additional passivation layers and alignment layers can be used in the displays described above. The materials used for the components of the displays, such as the liquid crystal layer, the polarization films, the quarter-wave plates, the half-wave plates, and the retardation films, can use materials and have parameters different from those described above. The retardation values d·Δn of the films can be different from those described above. The controller for controlling the percentage of the pixel data voltage applied to the liquid crystal cell can be different from a transistor switch. For example, the controller can be configured to apply three different percentages of the pixel data voltage to the liquid crystal cell depending on three different operating states of the display. When the display is operating in the transmissive mode in which the backlight module is turned on, some ambient light may be reflected by the transflector, so the display can operate in both the transmissive and reflective modes at the same time.

The orientations of the liquid crystal molecules described above refer to the directions of directors of the liquid crystal molecules. The molecules do not necessarily all point to the same direction all the time. The molecules may tend to point more in one direction (represented by the director) over time than other directions. For example, the phrase “the liquid crystal molecules are substantially aligned along a direction normal to the substrates” means that the average direction of the directors of the liquid crystal molecules are aligned along the normal direction, but the individual molecules may point to different directions. Other implementations and applications are also within the scope of the following claims.

What is claimed is:

1. An apparatus comprising;
a display comprising
pixel circuits each comprising:
a liquid crystal layer;
a storage capacitor to store an electric charge corresponding to a data voltage; and
a controller to enable different percentages of the data voltage to be applied to the liquid crystal layer depending on an operation state of the display.

2. The apparatus of claim 1 wherein the controller comprises a switch.

3. The apparatus of claim 2 wherein the switch comprises a transistor.

4. The apparatus of claim 2, further comprising a control line coupled to the switches of the pixel circuits, the control line having a first logic state when the display is operating in a transmissive mode and a second logic state when the display is operating in a reflective mode.

5. The apparatus of claim 1 wherein the controller causes a higher percentage of the data voltage to be applied to the liquid crystal layer when the display is operating in a transmissive mode, and causes the lower percentage of the data voltage to be applied to the liquid crystal layer when the display is operating in a reflective mode.

6. The apparatus of claim 1 wherein the liquid crystal layer comprises liquid crystal molecules having orientations that change depending on an amount of voltage applied to the liquid crystal layer.

7. The apparatus of claim 1 wherein each pixel circuit comprises a second capacitor, and the controller controls whether the data voltage is applied to (i) the liquid crystal layer and not the second capacitor, or (ii) to both the liquid crystal layer and the second capacitor.

8. The apparatus of claim 1 wherein each pixel circuit comprises a second capacitor having an electrode that is electrically floating when the display shows images when operating in a reflective mode.

9. The apparatus of claim 8, further comprising a second switch connected to provide a discharge path from the electrode of the second capacitor.

10. The apparatus of claim 1 wherein each pixel circuit comprises a second capacitor, the liquid crystal layer is between a first conductive layer and a second conductive layer, the second capacitor comprises a dielectric layer between the second conductive layer and a third conductive layer, and the controller controls whether the second conductive layer is electrically coupled to a third conductive layer.

11. The apparatus of claim 1, further comprising a transflective layer that partially transmits light and partially reflects light.

12. The apparatus of claim 1, further comprising a first linear polarizer, a first half-wave plate, a first quarter-wave plate, a second linear polarizer, a second half-wave plate, and a second quarter-wave plate, wherein the first linear polarizer, the first half-wave plate, and the first quarter-wave plate are positioned on a first side of the liquid crystal layer, and the second linear polarizer, the second half-wave plate, and the second quarter-wave plate are positioned on a second side of the liquid crystal layer.

13. The apparatus of claim 12 wherein the first half-wave plate has an extraordinary axis that is at an angle between 10 to 20 degrees relative to a transmission axis of the first polarizer.

14. The apparatus of claim 13 wherein the second half-wave plate has an extraordinary axis that is at an angle between 10 to 20 degrees relative to a transmission axis of the second polarizer.

15. The apparatus of claim 13 wherein the first quarter-wave plate has an extraordinary axis that is at an angle between 70 to 80 degrees relative to the transmission axis of the first polarizer.

16. The apparatus of claim 15 wherein the second quarter-wave plate has an extraordinary axis that is at an angle between 70 to 80 degrees relative to a transmission axis of the second polarizer.

17. The apparatus of claim 12, further comprising a compensation film to increase a viewing angle of the display.

18. The apparatus of claim 17 wherein the compensation film has an ordinary refractive index that is larger than an extraordinary refractive index.

19. The display of claim 1, further comprising a control unit to control the percentage of the data voltage applied to the liquid crystal layer based on a user activity state.

20. The display of claim 1, further comprising a control unit to control the percentage of the data voltage applied to the liquid crystal layer based on a level of ambient light.

21. An apparatus comprising
a display comprising pixel circuits each comprising a liquid crystal layer, in which the display is capable of switching between a transmissive mode and a reflective mode by changing a percentage of a data voltage applied to the liquid crystal layer of each pixel circuit, the data voltage being associated with a gray level.

22. The display of claim 21 wherein a higher percentage of the data voltage is applied to a portion of the liquid crystal layer when the display is operating in the transmissive mode, and a lower percentage of the data voltage is applied to the same portion of the liquid crystal layer when the display is operating in the reflective mode.

23. The display of claim 21 wherein each pixel circuit comprises a storage capacitor for storing an electric charge corresponding to the data voltage, a driving transistor for driving the storage capacitor to store the electric charge, and a switch transistor for controlling whether a higher percentage or a lower percentage of the data voltage is applied to the portion of the liquid crystal layer.

24. The display of claim 21 wherein the pixel circuit comprises a switch having a first state and a second state, the switch in the first state enabling the data voltage to be applied to the liquid crystal layer, the switch in the second state enabling the data voltage to be applied to the liquid crystal layer and a second capacitor coupled in series with the liquid crystal layer.

25. A display comprising
pixel circuits, each pixel circuit comprising
a liquid crystal layer, in which a portion of the liquid crystal layer is used to modulate light when the display is operating in a transmissive mode, and the same portion of the liquid crystal layer is used to modulate light when the display is operating in a reflective mode, and
circuitry to control the amount of tilt of liquid crystal molecules in the liquid crystal layer for a given pixel data according to an operating mode of the display.

26. The display of claim 25 in which, for a given pixel data, the circuitry controls the liquid crystal molecules to tilt at a larger angle relative to a reference direction when the display is operating in a transmissive mode and to tilt at a smaller angle relative to the reference direction when the display is operating in a reflective mode.

27. The display of claim 25 wherein the circuitry comprises a switch that enables a capacitor to be in series connection with the liquid crystal layer when the display is operating in the reflective mode and short-circuits the capacitor when the display is operating in the transmissive mode.

28. An apparatus comprising
a liquid crystal cell;
a first capacitor to store an electric charge corresponding to a data voltage associated with a gray-scale level;
a second capacitor positioned in series with the liquid crystal cell, the second capacitor having a first node and a second node;
a first transistor for driving the first capacitor; and
a second transistor having a first node and a second node, the first and second nodes of the second transistor being coupled to the first and second nodes, respectively, of the second capacitor.

29. The apparatus of claim 28, further comprising a third transistor to control discharge of electric charges accumulated at one of the first and second nodes of the second capacitor.

30. A display comprising
a first conducting layer;
a second conducting layer;
a third conducting layer;
a dielectric layer between the first and second conducting layers;
a liquid crystal layer between the second and third conducting layers;
a storage capacitor to apply a pixel data voltage to the first and third conducting layers; and
a control unit to short-circuit the first and second conducting layers when operating the display in a reflective mode.

31. The display of claim 30, further comprising a transflector between the liquid crystal layer and the second conducting layer.

32. The display of claim 30, further comprising a transflector between the first and second conducting layers.

33. A method comprising:
storing an electric charge in a storage capacitor of a pixel circuit of a display, the electric charge corresponding to a data voltage; and
applying a percentage of the data voltage to a liquid crystal layer of the pixel circuit based on the transmissive or reflective operating mode of the display.

34. The method of claim 33 wherein applying a percentage of the data voltage to the liquid crystal layer comprises applying a higher percentage of the data voltage to the liquid crystal layer when the display is operating in the transmissive mode, and applying a lower percentage of the data voltage to the liquid crystal layer when the display is operating in the reflective mode.

35. The method of claim 33 wherein applying a percentage of the data voltage to the liquid crystal layer comprises applying the data voltage to a combination of a second capacitor and the liquid crystal layer.

36. The method of claim 35, further comprising discharging charges accumulated on a floating electrode of the second capacitor.

37. The method of claim 33, further comprising controlling a switch to determine whether to apply a higher percentage or a lower percentage of the data voltage to the liquid crystal layer.

38. The method of claim 37 wherein the liquid crystal layer is between a first conductive layer and a second conductive layer, the second capacitor comprises a dielectric layer positioned between the second conductive layer and a third conductive layer, and controlling the switch comprises controlling whether the second conducive layer is electrically coupled to the third conductive layer.

39. A method comprising:
sending pixel data to a display capable of operating in a transmissive mode and a reflective mode, the data voltage being independent of the operating mode of the display; and
controlling a percentage of the data voltage applied to pixel circuits of the display based on whether the display is operating in the transmissive mode or the reflective mode.

40. The method of claim 39 wherein controlling the percentage the data voltage applied to one of the pixel circuits comprises controlling whether the data voltage is applied to a capacitor in series with a liquid crystal layer of the pixel circuit, or to the liquid crystal layer but not the capacitor.

41. A method comprising:
sending a data voltage to a display, the data voltage corresponding to a gray level to be shown on a pixel of the display, the pixel comprising a liquid crystal layer; and
controlling an amount of tilt of liquid crystal molecules in the liquid crystal layer based on the data voltage and whether the display is operating in a transmissive mode or a reflective mode.

42. The method of claim 41 wherein controlling the amount of tilt of liquid crystal molecules comprises controlling the liquid crystal molecules to tilt at a larger angle relative to a reference direction when the display is operating in the transmissive mode and to tilt at a smaller angle relative to the reference direction when the display is operating in the reflective mode.

43. A method comprising
controlling delivery of pixel data voltages from a data line to a first capacitor;
during a first time period, applying pixel data voltages to a liquid crystal cell of the pixel and a second capacitor; and
during a second time period, short-circuiting the second capacitor to apply the pixel data voltages to the liquid crystal cell.

44. The method of claim 43, further comprising discharging electric charges accumulated at an electrode of the second capacitor.

45. A method comprising:
discharging charges accumulated on a floating electrode of a capacitor, the capacitor being connected in series with a liquid crystal cell to reduce an amount of pixel data voltage applied to the liquid crystal cell when operating a display in a reflective mode.

46. The method of claim 45 in which discharging the charges comprises turning on a switch to allow the charges to flow to a reference node.

47. The method of claim 45 in which discharging the charges comprises setting a pixel data voltage of a data line to a reference voltage and electrically connecting the electrode of the capacitor to the data line.
